(19) United States
(12) Patent Application Publication
(10) Pub. No.: US 2011/0302069 A1
(43) Pub. Date: Dec. 8, 2011

(54) Treasury Funded Structured Settlements

(76) Inventor: John McCulloch, Bolingbrook, IL (US)

(21) Appl. No.: 12/792,246

(22) Filed: Jun. 2, 2010

(51) Int. Cl. G06Q 40/00; G06Q 50/00

(52) U.S. Cl. 705/37

(57) ABSTRACT

Maximizing the safety of funds paid by a defendant for the benefit of a claimant as specified in a structured settlement agreement in settlement of a personal liability or worker's compensation claim, and minimizing income taxes due from the claimant as a result of the receipt of payments arising from the settlement. A trust is established as owner of trust property, which is provided by the defendant; substantially all of the trust property is invested in uniquely identified United States Treasury obligations; and periodic payments to the claimant are made in accordance with the payment schedule using proceeds derived from the trust property. The claimant is provided with a security interest in the United States Treasury obligations that will be automatically perfected in the event of the bankruptcy of the safekeeper.

### BACKGROUND

A structured settlement is the settlement of a claim or lawsuit involving the use of future periodic payments. Structured settlements evolved from the Thalidomide cases in the 1960's. Many babies were born with serious limb deformities to women who had used Thalidomide for the treatment of morning sickness. Periodic payments were developed as a way of addressing the long-term needs of those affected children. Federal legislation was passed in 1983 which allowed all immediate and future payments used for the settlement of physical injury and physical sickness claims to be income tax-free and assigned to a life insurance company subsidiary (known as an Assignment Company) for the express purpose of paying structured settlements. In 1997, the Tax Code was expanded to grant the same preferred status to Workers' Compensation structured settlements.

Payments are typically funded with an annuity policy, and the policy's payout can be customized for a particular Claimant's situation. An insurance company typically issues the annuity policy and administers the payments. The obligation to make the future payments is often assigned to a third-party company, usually a wholly owned subsidiary of the insurance company, known as an Assignment Company.

Benefits of Structured Settlements may include any or all of the following:

Customized tax-favored financial options. Structured Settlements may provide Claimants a variety of individualized, long-term, tax-favored options meeting all types of specific long-term monetary needs.

Capital protection. Structured Settlements reduce the possibility of settlement funds being dissipated within a short period of time.

Low risk. There are significant risks to all parties if a case goes to trial. Verdicts go in surprising and unpredictable directions and the cost of litigation is high. Structured Settlements can enhance the odds of a successful conclusion before trial by focusing on the Claimant's needs during the settlement process.

Professional money management. Structured Settlements provide the Claimant the benefit of on-going professional money management, typically comprising a team of professionals to manage assets so that the investments are not dependent on any one individual.

Stability and security. Ordinarily, Structured Settlements may provide reliability, even in the face of an unstable financial marketplace. Annuities can provide secure and competitive guaranteed investments backed by large financial institutions.

However, during a severe economic downturn, even large financial institutions can be subject to significant risk of insolvency. A Structured Settlement method is needed that is not dependent upon investments that may entail a significant risk of insolvency in a severe economic downturn, while providing the benefits of conventional Structured Settlements.

### SUMMARY

Methods and documentation are provided for maximizing the safety of funds paid by a defendant for the benefit of a claimant as specified in a structured settlement agreement in settlement of a personal liability or worker's compensation claim, and minimizing income taxes due from the claimant as a result of the receipt of payments arising from the settlement. The structured settlement agreement includes a payment schedule setting forth the number, size, and timing of periodic payments to be paid to the claimant. A trust is established as owner of trust property, which is provided by the defendant; substantially all of the trust property is invested in uniquely identified United States Treasury obligations; and periodic payments to the claimant are made in accordance with the payment schedule using proceeds derived from the trust property. The claimant is provided with a security interest in the uniquely identified United States Treasury obligations that will be automatically perfected in the event of the incapacity or bankruptcy of the safekeeper.

It is to be understood that both the foregoing general description and the following detailed description are exemplary and explanatory and are intended to provide a brief explanation of the invention as claimed.

### BRIEF DESCRIPTION OF THE DRAWINGS

The accompanying drawings, which are included to provide a further understanding of the invention and are incorporated in and constitute a part of this specification, illustrate embodiments or aspects of the invention, and together with the description serve to explain the principles of the invention.

In the drawings:

FIG. 1 is a simplified block diagram of an exemplary network suitable for use in accomplishing the herein disclosed systems and methods;

FIG. 2 is a simplified block diagram of an exemplary computer system suitable for use in accomplishing the herein disclosed systems and methods;

FIG. 3 is a block diagram illustrating transactions between cooperating parties in accordance with the herein disclosed systems and methods; and

FIG. 4 flow chart illustrating method steps in accordance with the herein disclosed systems and methods.

### DETAILED DESCRIPTION

United States (US) Treasury Securities are direct debt obligations issued by the US government. The government uses the revenue from the securities to raise capital and/or make payments on outstanding debt. Since Treasury securities are backed by the full faith and credit of the US government, they are generally considered to be free of credit risk and typically carry lower yields than other securities. The rates on Treasury securities have traditionally been used as the benchmark for interest rates throughout the US economy and international capital markets.

Ordinarily, interest income from Treasuries is subject to federal income taxes. However, under some specific circumstances, such interest income is not subject to federal income taxes, as will be discussed hereinafter. Moreover, interest income from Treasuries is exempt from state and local income taxes. As a result, although the stated interest rate of Treasuries may be less than that of fully taxable securities, Treasuries may provide greater returns after taxes are taken into account. Generally the higher an investor's state and/or local tax bracket, the more beneficial investing in US Treasuries may be.

Accordingly, investing funds in US Treasuries can maximize the safety of those funds, while providing after-tax returns that may rival or exceed the returns of ordinary taxable investments.

Goals of estate planning include ensuring the safety of capital of the estate, maximizing the return on investments of the estate, and minimizing taxes owed on income of the estate. In the event of a monetary settlement of a Claimant's cause of action (claim) against a Defendant, in which the claim is a personal injury claim or a Worker's Compensation claim, one way of meeting those goals is with a structured settlement. A Settlement Trust can be used to effect the structured settlement. A Donor (creator, grantor) of the trust provides assets to the trust (trust property), such as one or more lump sum payments. Trustees of the Trust invest and manage the trust property, and periodic payments are made by the trust to the Claimant, derived from the trust property.

The herein described systems and methods pertain to the creation of a structured settlement trust that maximizes the safety of the trust property and eliminates taxes owed on income provided by the trust. This type of trust is referred to herein as a Treasury Funded Structured Settlement™ (TFSS™)¹. The herein disclosed systems and methods combine known approaches to securing capital and reducing income taxes in a novel way to maximize the safety of capital from a settlement and to provide peace of mind to a claimant.

As used herein, the following terms and definitions apply.

“Asset” means any claim, title or interest, whether legal or equitable, in property of whatever nature, whether real, personal or intangible, and wherever located.

“Beneficiary” means a beneficiary of a Trust.

“Claimant” means a person who, pursuant to a Structured Settlement Agreement, has settled a claim for his or her own physical personal injury as described in Section 104(a) of the Internal Revenue Code (IRC), and any successor in interest to such person, including but not limited to, any guardian or conservator appointed by a court for such person.

“Code” means the Internal Revenue Code of 1986, as amended, and corresponding provisions of subsequent federal tax laws, including all regulations promulgated thereunder.

“Defendant” means a defending party (whether as a respondent to a claim or as a defendant in a civil proceeding) in a dispute involving liability for physical personal injury or sickness who becomes a party to a Structured Settlement Agreement, and any insurer of such defending party.

“Documentation” means information fixed in one or more tangible media including, without limitation, one or more sheets of paper, one or more computer-readable storage devices, and one or more audio or video recordings;

“Donor” means an assignor, transferor, and/or deliverer of Trust Property to a Trustee to fund a Trust.

“Donor's Obligations” means the obligations of a donor to a Claimant under a Structure Settlement Agreement.

“Funding Amounts” means funds added to a Trust by a Defendant or its insurer pursuant to a Structured Settlement Agreement.

“Include” and “including” mean including without limitation, and do not limit the generality of any language which precedes such term.

“Independent Trustee” means a person who is not (a) an entity or (b) an employee, director, shareholder of one percent (1%) or more of the common stock, limited partner, general partner or representative of or in any entity, which entity provides services of any kind, other than as Trustee, to a Trust for compensation.

“Person” means an individual, partnership, corporation, trust or other cooperating entity, or any governmental or political subdivision.

“Power” means a right, title, privilege, discretion, limitation, immunity, duty, liability and obligation, of whatever type or nature. Any power that is granted or authorized or that “may” be exercised, as distinguished from any action which “shall” be taken, is a discretionary power that may but need not be exercised, in the sole discretion of the possessor.

“Property” means one or more Assets.

“Service administrator” means an entity active in the structured settlement industry which provides administrative services to a Trust.

“Structured Settlement” means the obligation of a Defendant to make periodic payments to a Claimant.

“Structured Settlement Agreement” means an agreement reached by a Defendant, a Claimant, and a Donor under which a Structured Settlement is established.

“Trust” means a Structured Settlement Trust.

“Trust Agreement” means an agreement reached by a Defendant, a Claimant, and a Donor under which a Structured Settlement Trust is established.

“Trustee” means an assignee, transferee, and recipient of Trust Property from a Donor.

“Unable to act” means that a person is incapable of acting because of incapacity, failure to qualify, refusal to act as distinguished from an exercise of discretion under a power which results in the person refraining from acting, death, resignation or, in the case of an Independent Trustee, the loss of qualification as an Independent Trustee.

In embodiments of the herein disclosed methods and systems, at least some of the steps of the methods disclosed may be encoded in one or more software programs which may be adapted for execution on any one of a variety of known computing devices such as personal computers (PCs), server computers, or the like, using any one of a number of different operating systems such as Windows™, Unix™, MacOS™, or the like, and/or network protocols such as Ethernet, TCP/IP, or the like. Depending on the size of a financial service using one or more of the herein described systems and methods, there may be one or more professionals providing financial services to one or more clients. Accordingly, such software programs may be adapted for installation and use in a standalone computer environment, or for installation and use in a file server environment, such as via a local area network or over the Internet. Such computing environments may comprise volatile data storage such as random access memory (RAM), non-volatile storage such as one or more hard drives, flash drives, and the like, and one or more processors, such as Pentium™ and Itanium™ processors produced by Intel Corporation. The software may be stored on a network server or hard drive, or on a portable storage medium such as an optical disk or flash drive. A computer product for use by a user to perform some or all of the method steps of the herein disclosed methods may comprise such a storage medium storing computer readable instructions which, when read by a general or special purpose computer, cause the computer to perform those method steps.

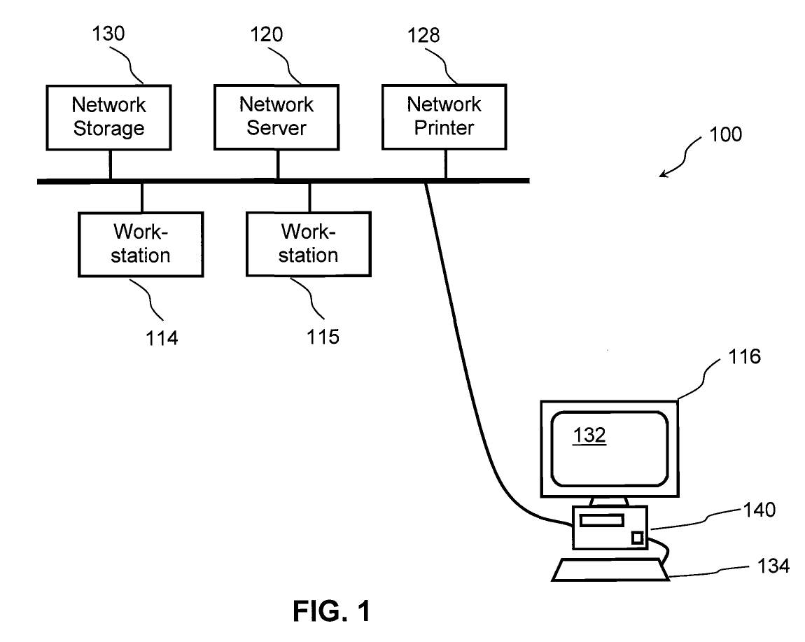

FIG. 1 is a simplified schematic diagram of an exemplary computer platform for use in accordance with the herein disclosed systems and methods. Local area network (LAN) 100 in which a communications medium 110, interconnects one or more workstations 114-116, a network printer 118, a network server 120, and network storage 130; each coupled to the communications medium 110. The network may use any of a number of known network topologies. The networked devices communicate with each other using communication protocols established by the network operating system software, which may be installed in the network server 120. Each of the workstations, as shown by the workstation 116, include a computer 140 comprising a processor, memory, and storage, coupled to the network, for example, through a network interface card (NIC), thereby allowing work station 116 to communicate with the other network connected workstations 114, 115, the network printer 118, the network server 120, and the network storage 130. The workstation 116 further includes a display 132 and an input device 134. The input device may be of a known type, such as a keyboard, mouse, or any other known type input signaling device which may be considered suitable by those skilled in the art for use in the operation of the herein disclosed methods and systems.

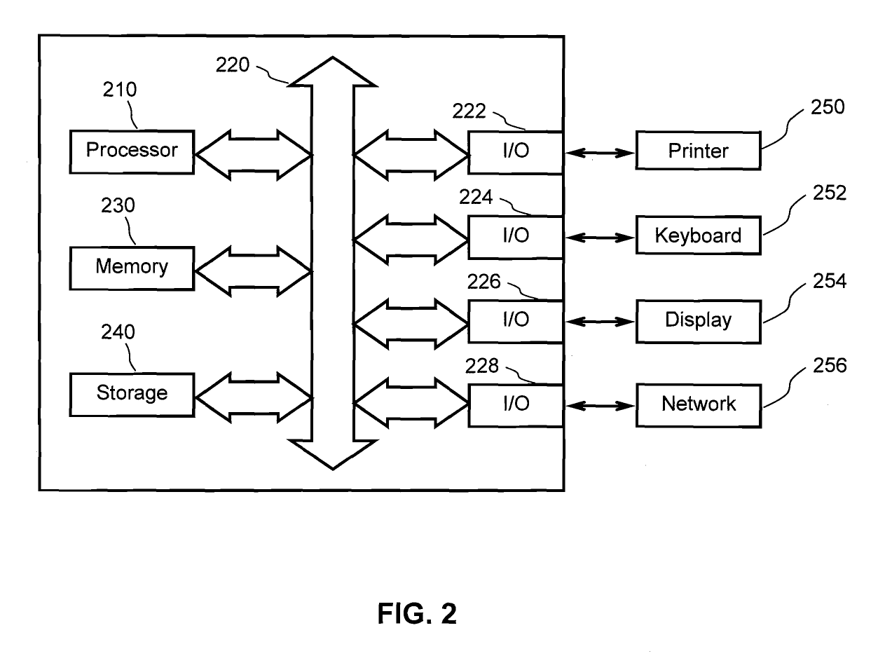

FIG. 2 is a simplified schematic diagram of the exemplary computer system 116 for use in accomplishing the herein disclosed systems and methods. Computer system 116 includes a central processing unit (CPU) 210 connected through a bus 220 to a plurality of input/output (I/O) ports 222-228, to a volatile random access signal memory (RAM) 230, and a non-volatile storage 240. The I/O ports 222-228 connect the CPU 210 to a printer 250, a keyboard 252, a display 254, and a network 256. Other configurations are possible, as would be understood by those of skill in the art, while maintaining the ability of the computer system to accomplish the herein disclosed systems and methods.

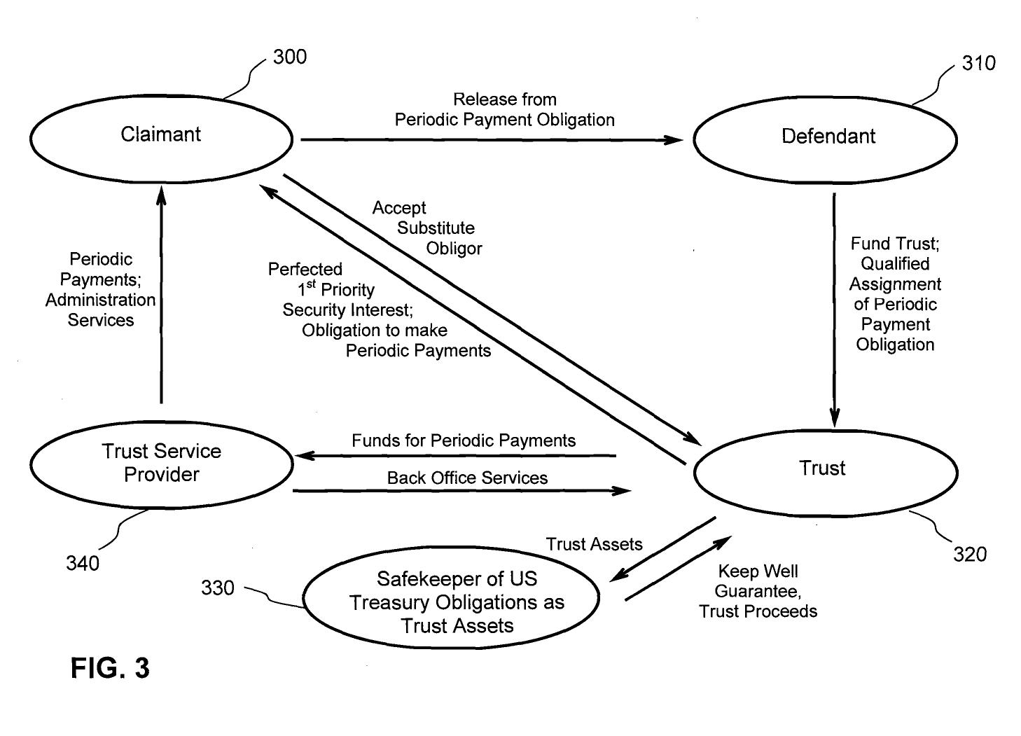

FIG. 3 is a block diagram showing exemplary transactions between cooperating parties in the creation and operation of a Structured Settlement Trust. Illustratively, Claimant 300 is a plaintiff with a claim against Defendant 310, such as a personal injury or worker's compensation claim. Claimant 300 and Defendant 310 negotiate a Settlement Agreement to settle the claim. Under the terms of the Settlement Agreement, Defendant 310 agrees to make Periodic Payments to Claimant 300. The parties intend for the Periodic Payments to be excludable from the Claimant's gross income under Internal Revenue Code (“Code”) §104(a)(2). The Settlement Agreement is memorialized in Settlement Agreement documentation and executed by Claimant 300 and Defendant 310. The Settlement Agreement includes information of the number, amount, and timing of Periodic Payments, which are set forth in a schedule (Payment Schedule) incorporated into the Settlement Agreement documentation.

In order to comport with provisions of the Code, the Settlement Agreement may provide that the Periodic Payments may not be accelerated, deferred, increased, or decreased, and that Claimant 300 shall not have the power to sell, mortgage, encumber, or anticipate the Periodic Payments, or any part thereof, by assignment or otherwise, without the approval of a court of competent jurisdiction. The Settlement Agreement provides for the establishment of a Trust 320. To establish Trust 320, a Trust Agreement is typically executed by Defendant 310 and one or more Trustees (not shown). An insurer (not shown) of Defendant 310 may also be a party to the Trust Agreement as a Donor of trust property.

The Settlement Agreement may permit Defendant 310 to assign its liability to make the Periodic Payments to Trust 320 by way of a Qualified Assignment pursuant to Code §130(c). To do so, Assignment Agreement documentation may be executed by Defendant 310 and the Trustees, assigning to Trust 320 the liability of Defendant 310 to make the agreed-upon Periodic Payments to Claimant 300. The Settlement Agreement further provides for Defendant 310 as a Donor of Trust Property to pay one or more lump sum amounts (“Lump-Sum Payments”) to Treasury Trust 320 to fund its liability to make the Periodic Payments by purchasing uniquely identified direct obligations of the United States (the “Treasury Obligations”). The Treasury Obligations will result in future payments to Trust 320, and are selected such that the payments to be received by Trust 320 by virtue of the Treasury Obligations will be reasonably related to the Payment Schedule, and will not exceed the amounts of the Periodic Payments. The Settlement Agreement provides that Claimant 300 is a secured creditor of Trust 320, and that Trust 320 pledges the uniquely identified Treasury Obligations to secure its promise to make the Periodic Payments.

Like the Settlement Agreement, the Assignment Agreement may provide that the Periodic Payments may not be accelerated, deferred, increased, or decreased, and that Claimant 300 does not have the power to sell, mortgage, encumber, or anticipate the Periodic Payments, or any part thereof, by assignment or otherwise, without the approval of a court of competent jurisdiction. The Assignment Agreement also provides that Claimant 300 is a secured creditor of Trust 320, with the uniquely identified Treasury Obligations serving as collateral for the Trust's promise to make the Periodic Payments.

The Technical and Miscellaneous Revenue Act of 1988 (TAMRA) provided for greater than general creditor status under IRC 130. Private Letter Ruling (PLR) 9253045 details taking possession of an annuity contract under a secured creditor. Accordingly, in embodiments, a claimant may perfect his security interest in either of two ways. One way is for the claimant to take possession of the Treasuries. The other way is to allow the Treasuries to remain in the trust subject to a “control agreement” until a successor trustee is established. Automatic perfection of the Claimant's security interest may be provided for in any of the documentation identified herein.

In an embodiment, Claimant 300 is not designated as a beneficiary of the Trust, and has no ownership rights in the uniquely identified Treasury Obligations other than the rights of a secured creditor. Rather, the Trust maintains ownership rights in the Treasury Obligations. As such, the Trust will receive revenue derived from ownership of the Treasury Obligations, and will use such revenue to discharge its assumed obligation to make the Periodic Payments under the Assignment Agreement. The Trust's business purpose may be restricted to accepting funds from Defendants 310 and investing those funds solely in uniquely identified Treasury Obligations which it designates as taken into account under Code §130 with respect to the Assignment. Because the Periodic Payments are funded with the Treasury Obligations, the Payment Schedule may comprise a certain number of identical, pre-determined payments followed by one final payment which will be in a similar amount. However, the parties to the Trust Agreement may not be able to determine the precise amount of the final payment until the Trust receives payment from the Defendant or its insurer in accordance with the Settlement Agreement and purchases the Treasury Obligations.

Claimant 300, after receiving some Periodic Payments, may seek to receive from the Trust a lump sum payment in lieu of some or all of the remaining Periodic Payments. Such a request might be made, for example, if Claimant 300 requires a large amount of cash to purchase a home, pay educational expenses or pay unanticipated medical bills. The Trust may consider such a request and may agree to substitute a lump sum for all or a portion of the remaining Periodic Payments (a “Subsequent Commutation Transaction”). The previously identified documentation may provide for such a substitute payment upon the approval of the trustees. If the Trust agrees to a Subsequent Commutation Transaction, the Claimant 300 and the Trust may memorialize that agreement by entering into a Transfer Agreement. Typically, the transfer agreement must be approved by a court of competent jurisdiction before the transaction is completed.

In an embodiment, a bank or other financial institution or the like may be designated as “Safekeeper” 330, and possession of the uniquely identified Treasury Obligations may be transferred to the Safekeeper to hold assets of the Trust for safekeeping. In general, assets held by such a Safekeeper in trust are not part of the Safekeeper's assets, nor are they legally subject to claims of the Safekeeper's creditors, even if the Safekeeper should become insolvent. Furthermore, because Claimant 300 is given secured creditor status, in the unlikely event anything were to happen to the Safekeeper, the Trust would continue to hold the uniquely identified Treasury Obligations that fund the Claimant's Structured Settlement, and the Claimant would continue to have a security interest in the uniquely identified Treasury Obligations. Because creditors of the Safekeeper may not reach the assets held by the Trust, and also because Treasury Obligations are the most secure investments available, Claimant 300 is provided with maximal safety and security, and corresponding peace of mind.

In an embodiment, to provide even further peace of mind to Claimant 300, Safekeeper 330 may enter into a Corporate Keep Well Agreement (KWA) with the Claimant, with the Safekeeper pledging that the assets held in the Trust may not be used for any purpose other than paying the Claimant. The KWA can be used in combination with the existing protections already afforded by banking and trust law, regulatory banking oversight, internal and external audits, and Directors and Officers (D&O) insurance coverage to cover any liabilities associated with their handling of the trust assets.

A Structured Settlement can be structured to pay monthly, semi-annually, annually, and/or periodic payments, for up to 30 years, i.e., the maximum lifetime of a US Treasury security. The payments can be customized to meet the known current and future needs of the Claimant during the time of settlement. To do so, the trust property may be fully invested in one or more of Treasury Bills, Treasury Notes, Treasury Bonds, and Treasury Inflation—Protected Securities (TIPS). Treasury Bills are short-term US government securities with maturities ranging from a few days to 52 weeks. Bills are sold as a discount from their face value. Treasury Notes are US government securities that are issued with maturities of 2, 3, 5, 7 or 10 years, and pay interest every six months. Treasury Bonds pay interest every six months and mature in 30 years. Treasury Inflation—Protected Securities (TIPS) are inflation-indexed bonds issued by the U.S. Treasury, whose principal is adjusted by changes in the Consumer Price Index (CPI). TIPS pay interest every six months and are issued with maturities of 5, 10 and 30 years.

Moreover, trust property may be partially or fully invested in so-called strips. Although US government securities are not issued as zero coupon bonds, the remaining interest payments on all securities can be “stripped” from the principal to make up multiple zero coupon bonds with six month maturities. These bonds can then be traded as independent negotiable zero coupon securities called strips. There are a number of types of Treasury strips. Some have been stripped by the Treasury itself, while others have been stripped by private dealers. There are also a number of series within each type. Some stripped Treasuries are more liquid than others.

Strips are traded on a yield basis. A strip's yield and settlement date are used to calculate its price. Therefore, a change in the settlement date will affect the price. Zero coupon security prices are particularly susceptible to the interest rate fluctuations that affect all securities.

In yet another embodiment, the Trust documentation can be set up to provide for the ability to request a commutation of some or all of the future payments, based on a legitimate need that is in the best interest of the Claimant. Such requests may be subject to approval of a court of competent jurisdiction. A framework can be provided for attorneys to handle a commutation request and administer paperwork as required under state transfer laws and IRC 5891.

Alternatively, the Trust may be set up to prevent such a sale from occurring, essentially the opposite of a 5891 Commutation. In such an embodiment, the trust administrator may refuse and oppose any factoring requests. The Settlement Agreement and/or other relevant documents may contain selected language to implement this restriction. If this language is selected, no 5891 Commutation can be allowed. This restriction may be used, for example, to prevent a spendthrift from depleting the trust, or to ensure the protection of the assets of particularly vulnerable claimants.

An Estate Commutation Rider can also selectively be included in the Settlement Agreement and/or other relevant documents. PLR 9812027 allows for commutation upon death of a primary payee, such as to pay taxes payable by the payee's estate, provided appropriate language is inserted into the Settlement Agreement and the Qualified Assignment. If this language is selected for inclusion in the documentation, the Treasuries held by the trust may be sold. In an embodiment, the decedent's estate may be paid up to 99% of the commuted value. This is in contrast to prior art practices in which typically only between 93-95% of the commuted value is passed to the estate.

In an embodiment, the trust may provide for an automatic commutation upon the death of the Claimant, providing beneficiaries designated by the Claimant with the funds needed to deal with estate taxes and other final expenses.

In an embodiment, a service provider 340 may provide services to the Trust including, but not limited to, bookkeeping, check disbursements, investment management, and the like.

In an embodiment, a safekeeper such as a bank can combine a plurality of TFSS Trusts into a single Trust used for paying a plurality of claimants. Alternatively, the safekeeper can prospectively set up a single TFSS Trust for holding all of the US Treasury securities on behalf of present and/or future Claimants. In these embodiments, when uniquely identified US Treasury securities are purchased for the Trust, specific securities can be identified, such as by their respective unique CUSIP (Committee on Uniform Security Identification Procedures) numbers, and associated with one or more corresponding uniquely identified specific Claimants. In the event one of the Claimants needs to perfect its security interest, the particular securities used to secure that Claimant's interest can thereby be identified. In operation, there is no overlapping of one Claimant's collateral with another. In this way, obligations to any of the Claimants will not impair nor in any way defeat other Claimants' rights to the Collateral or the benefits due them.

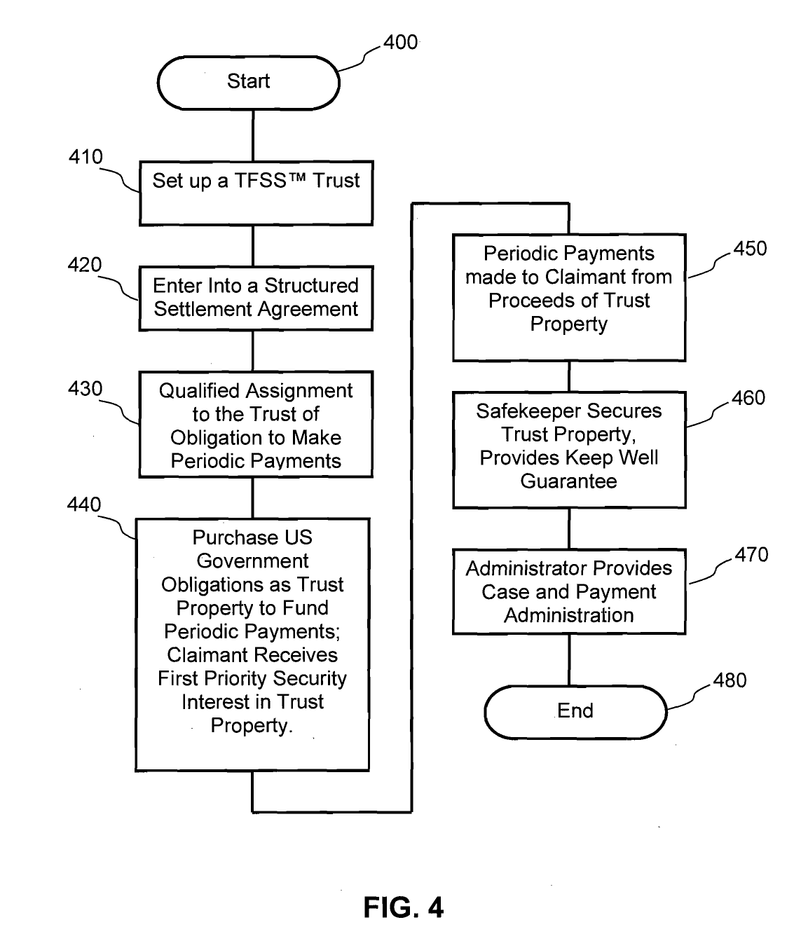

FIG. 4 is a flow chart showing steps performed in accordance with an embodiment of the herein disclosed systems and methods.

The exemplary method starts at block 400, and proceeds by setting up a TFSS Trust by a Safekeeper for use in providing payments to one or more prospective Claimants, 410. In due course, a Claimant enters into a Structured Settlement Agreement with a Defendant, 420. The Defendant or its insurer provides Trust Property to the Trust in the form of one or more lump sum payments, and a qualified assignment is made to the Trust of the Defendant's obligation to make Periodic Payments to the Claimant in accordance with the Structured Settlement Agreement, 430. The Trust Property is used to purchase uniquely identified US Treasury Obligations to fund the Periodic Payments, and the Claimant is provided with a First Priority Security Interest in the uniquely identified US Treasury Obligations, 440. Periodic Payments are made in accordance with a Payment Schedule of the Structured Settlement Agreement, 450, using proceeds of the Trust Property. Possession of the uniquely identified US Treasury Obligations is transferred to a designated Safekeeper, who secures the uniquely identified US Treasury Obligations, and provides a Keep Well Agreement to the Claimant, 460. An Administrator provides case and payment administration services, 470, for the duration of the settlement, after which time the process ends, 480. In the event of the bankruptcy of the Safekeeper, the Claimant can perfect his security interest in the uniquely identified US Treasury Obligations, providing additional peace of mind to the Claimant.

In summary, the TFSS™ delivers competitive pricing, commutation options, secured creditor status, keep well agreement, all while maximizing the safety and minimizing the tax consequences to the claimant of settlement funds paid by a defendant. The TFSS™ can be used in combination with conventional annuities to provide additional flexibility and diversification.

Although the various exemplary embodiments of the invention have been shown and described, various modifications, omissions, and additions may be made to the form and detail of the disclosed embodiments without departing from the spirit and scope of the invention, as recited in the following claims. Thus, it is intended that the present invention cover such modifications and variations provided they come within the scope of the following claims and their equivalents.

What is claimed is:

1. A method of maximizing the safety of funds paid by a defendant for the benefit of a claimant, as specified in a structured settlement agreement between the defendant and the claimant in settlement of a personal liability or worker's compensation claim, and minimizing income taxes due from the claimant as a result of the receipt of payments arising from the settlement, the method comprising the steps of:
establishing a trust as owner of trust property;
receiving in the trust at least one lump sum payment from at least one of the defendant and its insurer as donor;
investing substantially all of the trust property in uniquely identified United States Treasury obligations;
transferring possession of the uniquely identified Treasury obligations to a safekeeper;
establishing the claimant as a secured creditor of the trust;
pledging the uniquely identified Treasury obligations to secure the trust's liability to make the periodic payments;
making periodic payments of money to the claimant in accordance with a payment schedule using proceeds derived from the uniquely identified Treasury obligations; and
providing for the automatic perfection of the claimant's security interest in the uniquely identified Treasury obligations the event of the incapacity or bankruptcy of the safekeeper.

2. The method of claim 1, further comprising the steps of providing a computer processor programmed to generate documentation between the trust and the safekeeper, the documentation effecting a guarantee by the safekeeper to the claimant that the Treasury obligations shall not be used for anything other than paying the claimant; generating such documentation.

3. The method of claim 1, further comprising the step of guaranteeing by the safekeeper that the trust property will not be used for any purpose other than paying the claimant.

4. The method of claim 1, further comprising the step of administering the periodic payments by a trust service administrator.

5. The method of claim 4, wherein:
the trust has at least two trustees, at least one of whom is designated by the trust service administrator; and
a quorum of trustees cannot exist without the presence of at least one of the trust service administrator designated trustees.

6. The method of claim 1, wherein the schedule of periodic payments specifies that all of the periodic payments other than the final payment are of the same size.

7. The method of claim 1, wherein the schedule of periodic payments specifies that at least one of the periodic payments other than the final payment is not of the same size as the others.

8. The method of claim 1, wherein the structured settlement agreement provides:
the periodic payments will be made such that they are excludable from the claimant's income for the purposes of income taxes due under the Internal Revenue Code; and
the periodic payments may not be accelerated, deferred, increased, or decreased, and the claimant shall not have the power to sell, mortgage, encumber, or anticipate the payments or any part thereof, by assignment or otherwise, without the approval of a court of competent jurisdiction.

9. The method of claim 1, wherein the structured settlement agreement provides:
the periodic payments will be made such that they are excludable from the claimant's income for the purposes of income taxes due under the Internal Revenue Code; and
the periodic payments may be accelerated, deferred, increased, or decreased, and the claimant has the power to sell, mortgage, encumber, or anticipate the payments or any part thereof, by assignment or otherwise, without the approval of a court of competent jurisdiction.

10. Documentation for maximizing the safety of funds paid by a defendant for the benefit of a claimant, as specified in a structured settlement agreement between the defendant and the claimant in settlement of a personal liability or worker's compensation claim, and for minimizing income taxes due from the claimant as a result of the receipt of payments arising from the settlement, the documentation comprising provisions for:
establishing a trust as owner of trust property;
funding the trust with at least one lump sum payment received from at least one of the defendant and its insurer as donor;
investing substantially all of the trust property in uniquely identified United States Treasury obligations;
transferring possession of the uniquely identified United States Treasury obligations to a safekeeper;
releasing the defendant from liability for making the periodic payments;
assigning to the trust the liability for making the periodic payments;
establishing the claimant as a secured creditor of the trust;
pledging the uniquely identified United States Treasury obligations to secure the trust's liability to make the periodic payments;
making periodic payments of money to the claimant in accordance with the payment schedule using proceeds derived from the uniquely identified United States Treasury obligations; and
providing for the automatic perfection of the claimant's security interest in the uniquely identified United States Treasury obligations in the event of the incapacity or bankruptcy of the safekeeper.

11. The documentation of claim 9, further comprising provisions for guaranteeing by the safekeeper that the uniquely identified United States Treasury obligations in the safekeeper's possession will not be used for any purpose other than paying the claimant.

12. The documentation of claim 9, further comprising provisions for designating a trust service administrator to administer the periodic payments.

13. The documentation of claim 11, further comprising provisions for the selection of at least two trustees, at least one of whom is designated by the trust service administrator, and specifying that no quorum of trustees can exist without at least one of the trust service administrator designated trustees.

14. The documentation of claim 9, wherein the schedule of periodic payments specifies that all of the periodic payments other than the final payment are of equal size.

15. The documentation of claim 9, wherein the schedule of periodic payments specifies that at least one of the periodic payments other than the final payment is not of the same size as the others.

16. The documentation of claim 9, further comprising provisions for:
making the periodic payments such that they are excludable from the claimant's income for the purposes of income taxes due under the Internal Revenue Code; and
allowing the periodic payments to be accelerated, deferred, increased, or decreased, and allowing the claimant to sell, mortgage, encumber, or anticipate the payments or any part thereof, by assignment or otherwise, without the approval of a court of competent jurisdiction,

17. The documentation of claim 9, wherein at least a portion of the documentation is generated automatically using a computer processor, incorporating boilerplate language stored in a data storage device accessible to the processor, and incorporating information input by a user including information of at least one of the parties to at least a portion of the documentation.

18. A process of maximizing the security of payment obligations owed by a trust to a claimant as a result of a structured settlement agreement between a defendant and the claimant in settlement of a personal liability or worker's compensation claim, the method comprising the steps of:
providing a trust as owner of trust property that includes a payment from at least one of the defendant and its insurer, the claimant being identified as a secured creditor of the trust;
converting the trust property into uniquely identified United States Treasury obligations by purchasing such Treasury obligations using substantially all of the trust property;
pledging the uniquely identified Treasury obligations to secure the trust's liability to make the periodic payments;
transferring possession of the uniquely identified Treasury obligations to a safekeeper;
receiving proceeds from the Treasury obligations;
making periodic payments of money from the trust to the claimant in accordance with a payment schedule; and
providing for the automatic perfection of the claimant's security interest in the uniquely identified Treasury obligations the event of the incapacity or bankruptcy of the safekeeper.
